(19) United States
(12) Patent Application Publication
(10) Pub. No.: US 2022/0397746 A1
(43) Pub. Date: Dec. 15, 2022

(54) PROJECTION OBJECTIVE AND SCANNING DISPLAY DEVICE

(71) Applicant: CHENGDU IDEALSEE TECHNOLOGY CO., LTD., Chengdu, Sichuan (CN)

(72) Inventor: Chao Chen, Chengdu, Sichuan (CN)

(21) Appl. No.: 17/776,598

(22) PCT Filed: Nov. 18, 2020
(86) PCT No.: PCT/CN2020/129775

§ 371 Date: May 13, 2022

(30) Foreign Application Priority Data
Nov. 18, 2019 (CN) 201911128737.0
Nov. 18, 2019 (CN) 201911129878.4

(51) Int. Cl. G02B 13/16; G02B 13/00

(52) U.S. Cl. CPC G02B 13/16; G02B 13/002

(57) ABSTRACT

The disclosure relates to a projection objective and a scanning display device. The projection objective comprises a first and a second lens groups which are sequentially provided on a common optical axis from an object side to an image side. The first lens group comprises six lenses which are sequentially provided from an object side to an image side, where a first lens has an object side surface being a convex surface and an image side surface being a concave surface. The second lens group comprises five lenses which are sequentially provided from an object side to an image side, where a seventh lens with a biconcave lens and an eighth lens with a biconvex lens form a bi-cemented lens having a convex surface facing the image side; and an eleventh lens has an object side surface being a convex surface and an image side surface being a concave surface.

### CROSS-REFERENCE TO RELATED APPLICATIONS

The disclosure claims the priority of Chinese patent application CN201911128737.0 and the priority of Chinese patent application CN201911129878.4, both entitled “Projection Objective and Scanning Display Device” and filed on Nov. 18, 2019, the entireties of which are incorporated herein by reference.

### FIELD OF THE INVENTION

The disclosure relates to the technical field of display, and in particular, to a projection objective and a scanning display device.

### BACKGROUND OF THE INVENTION

The imaging principle of the optical fiber scanning and projection technology is to project information of each pixel of an image to be displayed to an imaging area by using an actuator to drive a scanning optical fiber to move along a predetermined two-dimensional scanning trajectory and meanwhile modulating a light emission power of a light source so as to form a projection image.

FIGS. 1A and 1B are diagrams of a structure of an existing optical fiber scanning and projection system, and FIG. 1B is a side view of FIG. 1A. The optical fiber scanning and projection system includes a processor 100, a laser unit 110, an optical fiber scanner 120, an optical fiber 130, a light source modulating module 140, a scanning driving module 150, and a light source beam-combining module 160. The optical fiber scanner 120 includes an actuator 121, a base 125, and a housing 124. The optical fiber 130 is fixed on the actuator 121, and a portion of the optical fiber that goes beyond the actuator 121 forms an optical fiber cantilever 122. During operation, the processor 100 sends an electrical control signal to the scanning driving module 150 so as to control the optical fiber scanner 120 to perform vibration scanning, and meanwhile the processor 100 sends an electrical control signal to the light source modulating module 140 so as to control a light emission power of the beam-combining module 160. The light source modulating module 140 outputs a light source modulating signal according to the received electrical control signal so as to modulate the laser unit(s) 110 of one or more colors in the light source beam-combining module 160. It is shown in the drawings that the light source beam-combining module 160 includes lasers of three colors, i.e., red (R), green (G), and yellow (Y). Light produced by the laser unit 110 of each color in the light source beam-combining module 160 is beam-combined so as to produce color and grayscale information of each pixel one by one, and a combined beam emitted from the light source beam-combining module is guided into the optical fiber scanner via the optical fiber. Synchronously, the scanning driving circuit 150 outputs a scanning driving signal according to the received electrical control signal so as to control the optical fiber 130 in the optical fiber scanner 120 to perform scanning movement along a predetermined two-dimensional scanning trajectory, in order to scan and output a light beam transmitted in the transmission optical fiber 130.

The projection objective is used to project an arc-shaped pattern on an image surface of the projection objective to an object surface of the projection objective, and is generally disposed on an emission optical path of an optical fiber emission end in the optical fiber scanner, i.e., a position as shown by numeral 123 in FIG. 1B. However, since an image surface obtained by scanning of the optical fiber scanner is an arc-shaped surface and an image surface of an existing projection objective (i.e., an image surface of an image source) is usually a flat surface, the existing projection objective cannot form a clear image of an arc-shaped surface image obtained by scanning of the optical fiber scanner.

### SUMMARY OF THE INVENTION

Embodiments of the disclosure is intended to provide a projection objective and a scanning display device, so as to solve the problem of arc-shaped image surface imaging in an optical fiber scanning and projection system, so as to form a clear image.

In order to solve the above problems, according to a first aspect, the disclosure provides a projection objective, including a first lens group and a second lens group which are sequentially provided on a common optical axis from an object side to an image side.

The first lens group includes six lenses, i.e. a first lens to a sixth lens, which are sequentially provided from the object side to the image side and have positive, negative, negative, negative, positive, and positive focal lengths in sequence; the first lens has an object side surface being a convex surface and an image side surface being a concave surface.

The second lens group includes five lenses, i.e. a seventh lens to an eleventh lens, which are sequentially provided from the object side to the image side and have negative, positive, positive, positive, and positive focal lengths in sequence; the seventh lens is a biconcave lens, and an eighth lens is a biconvex lens, the seventh lens and the eighth lens forming a bi-cemented lens having a convex surface facing the image side; and the eleventh lens has an object side surface being a convex surface and an image side surface being a concave surface.

In an embodiment of the disclosure, the first lens group has a focal length of F1, and the second lens group has a focal length of F2, F1 and F2 satisfying a relational expression:

1.5<F1/F2<2.0.

In an embodiment of the disclosure, a second lens has an object side surface being a convex surface and an image side surface being a concave surface; a third lens and a fourth lens are both biconcave lenses; a fifth lens has an image side surface being a convex surface; and the sixth lens is a biconvex lens.

In an embodiment of the disclosure, the first lens has a curvature radius of R1 at the object side surface and a curvature radius of R2 at the image side surface, R1 and R2 satisfying a following relational expression:

1<R1/R2<1.4.

In an embodiment of the disclosure, the second lens, the third lens, and the fourth lens have equivalent focal lengths of F3, and the fifth lens and the sixth lens have equivalent focal lengths of F4, F3 and F4 satisfying a following relational expression:

4<|F4/F3|<10.

In an embodiment of the disclosure, a distance between the object side surface of the first lens and an image surface of the projection objective is less than 4.5 cm.

In an embodiment of the disclosure, following relational expressions are further satisfied:

1.7<N1<1.9,

1.8<N2<2.0,

1.85<N3<2.0,

1.46<N4<1.65,

1.8<N5<2.0,

1.46<N6<1.65,

1.85<N7<2.0,

1.46<N8<1.65,

1.46<N9<1.65,

1.46<N10<1.65, and

1.65<N11<1.85,

where N1 is a refractive index of the first lens, N2 being a refractive index of the second lens, N3 being a refractive index of the third lens, N4 being a refractive index of the fourth lens, N5 being a refractive index of the fifth lens, N6 being a refractive index of the sixth lens, N7 being a refractive index of the seventh lens, N8 being a refractive index of the eighth lens, N9 being a refractive index of a ninth lens, N10 being a refractive index of a tenth lens, N11 being a refractive index of the eleventh lens.

In an embodiment of the disclosure, the second lens and the fifth lens are formed of the same material.

In an embodiment of the disclosure, the third lens and the seventh lens are formed of the same material.

In an embodiment of the disclosure, the fourth lens, the sixth lens, the eighth lens, the ninth lens, and the tenth lens are formed of the same material.

In an embodiment of the disclosure, the projection objective further includes a stop, which is disposed on a common optical axis between the sixth lens and the seventh lens.

In an embodiment of the disclosure, a distance from an image side surface of the sixth lens to the stop is T1, and a distance from the stop to an object side surface of the seventh lens is T2, T1 and T2 satisfying a relational expression:

T1<T2.

In an embodiment of the disclosure, the projection objective further includes a parallel flat plate, which is located between the eleventh lens and the image surface on a common optical axis with the eleventh lens for protecting the projection objective.

According to a second aspect, the disclosure provides a scanning display device, including an optical fiber scanner and the projection objective according to any one of claims 1 to 11 corresponding to the optical fiber scanner. The optical fiber scanner includes an actuator and an optical fiber fixed on the actuator, and a portion of the optical fiber that goes beyond the actuator forms an optical fiber cantilever. The actuator includes a first actuating portion and a second actuation portion connected to the first actuating portion. Under action of a driving signal, the first actuating portion moves in a first direction, the second actuating portion driving the first actuating portion to move in a second direction, the optical fiber cantilever moving in a combined direction of the first direction and the second direction. The first actuating portion has a movement frequency which is greater than or equal to a movement frequency of the second actuator.

In an embodiment of the disclosure, a curvature radius corresponding to a scanning trajectory of the optical fiber in the first direction driven by the actuator is [2.0 mm, 2.3 mm], and a scanning radius in the second direction is [2.3 mm, +∞], an equivalent focal length of the projection objective being 2 mm.

Solutions provided by embodiments of the disclosure will be explained further below.

In embodiments of the disclosure, a projection objective includes eleven lenses, i.e., a first lens to an eleventh lens, which are sequentially provided on a common optical axis from an object side to an image side and have positive, negative, negative, negative, positive, positive, negative, positive, positive, positive, and positive focal lengths in sequence. The first lens to a sixth lens form a first lens group, and a seventh lens to the eleventh lens form a second lens group. The first lens is a meniscus-shaped lens with a convex surface facing the object side, the sixth lens being a biconvex lens, a seventh lens being a biconcave lens, an eighth lens being a biconvex lens, the seventh lens and the eighth lens forming a bi-cemented lens having a convex surface facing the image side, the eleventh lens having an image side surface being a concave surface. Since a focal length of the first lens group is F1 and a focal length of the second lens group is F2, F1 and F2 satisfying a relational expression 1.5<F1/F2<2.0, a focal power of a system can be effectively dispersed, thereby reducing an image difference generated by respective lenses and forming a clear image.

### BRIEF DESCRIPTION OF THE DRAWINGS

FIGS. 1A and 1B are diagrams of a structure of an existing optical fiber scanning and projection system;

FIG. 2 is a structure and an imaging diagram (in a fast axis scanning direction) of a projection objective provided according to an embodiment of the disclosure;

FIG. 3 is an imaging diagram (in a slow axis scanning direction) of the projection objective provided according to an embodiment of the disclosure; and

FIGS. 4A to 7B are MTF curve graphs and distortion curve graphs when the projection objective according to the embodiment of the disclosure form an image for different optical fiber scanners.

### DETAILED DESCRIPTION OF THE EMBODIMENTS

Solutions in embodiments of the disclosure will be described clearly and completely with reference to drawings in the embodiments of the disclosure, and apparently the described embodiments are only part of the embodiments of the disclosure, rather than all of the embodiments. Based on the embodiments in the disclosure, all other embodiments obtained by those of ordinary skills in the art, without making creative efforts, fall into the protection scope of the disclosure.

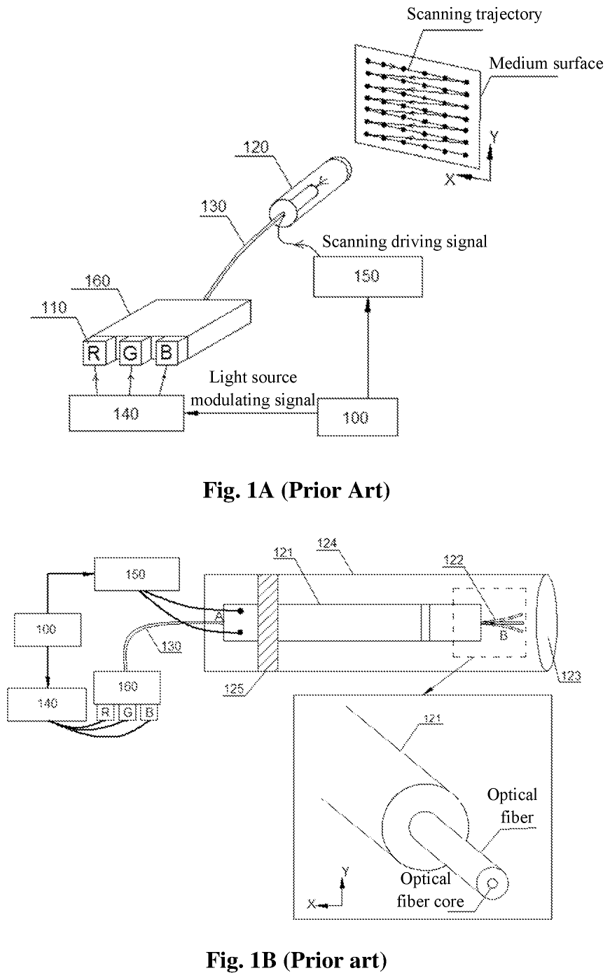

The projection objective provided by an embodiment of the disclosure is used to form an image of an arc-shaped pattern located on an image surface of the projection objective to an object surface of the projection objective, so as to solve the problem of arc-shaped image surface imaging. The arc-shaped pattern on the image surface is an arc-shaped scanning surface obtained by scanning of an optical fiber scanner as shown in FIGS. 1A to 1B or emitted by another image source. The object surface is a projection screen, a curtain, or a wall and the like.

Firstly, a scanning display device to which the projection objective is applied will be introduced for better understanding of those skilled in the art.

The scanning display device in the embodiment includes an optical fiber scanner and the above projection objective corresponding to the optical fiber scanner, and this device is active in a wavelength range which includes at least 400 nm to 700 nm. The optical fiber scanner includes an optical fiber and an actuator. The optical fiber is fixed on the actuator, and a portion of the optical fiber that goes beyond the actuator forms an optical fiber cantilever. The actuator includes a fast axis actuating portion and a slow axis actuating portion connected to the fast axis actuating portion. For example, the two actuating portions may be connected together by an adhesive, inlaying consolidation, or adding a fixed structure, or the actuator may be formed integrally. An integrally formed actuator may have a sheet-like shape or a column-like shape, or a combination of the sheet-like shape or the column-like shape. The column-like shape includes a cylinder-like shape and a square-column-like shape, such as a round rod (pipe) and a square rod (pipe). The fast axis actuating portion has a driving frequency that is greater than a driving frequency of the slow axis actuating portion. Under action of a driving signal, the fast axis actuating portion performs a scanning movement in a first direction, and the slow axis actuating portion drives the fast axis actuating portion to perform a scanning movement in a second direction. Driven by the actuator, the optical fiber cantilever performs a scanning movement along a predetermined two-dimensional scanning trajectory in a combined direction of the first direction and the second direction, for example by using grid scanning, spiral scanning and the like, so as to form an arc-shaped scanning surface (corresponding to the image surface of the projection objective). In some embodiments, the first direction is X direction, and the second direction is Y direction.

In actual application, by controlling the driving signal of the optical fiber scanner, a scanning trajectory corresponding to the optical fiber in the optical fiber scanner can be controlled. In the embodiment, it can be controlled that a curvature radius corresponding to a scanning trajectory of the optical fiber scanner in a fast axis direction (the X direction) is in a range of [2.0 mm, 2.3 mm] and that a curvature radius corresponding to a scanning trajectory in a slow axis direction (the Y direction) is greater than or equal to 2.3 mm, and an arc-shaped scanning surface formed correspondingly is the image surface of the projection objective. When the curvature radius of the scanning trajectory in the slow axis direction is “+∞”, it indicates that the scanning trajectory in the Y direction in an arc-shaped image surface has a radian which approximates a straight line, and at this time, the scanning surface is similar to a cylindrical surface. Since light emitted from the optical fiber of the optical fiber scanner has a small light spot, i.e., pixel units on a light emitting surface being small, it is required that a lens have a higher resolution, so as to form a clear image of the arc-shaped scanning surface emitted by the optical fiber scanner.

Next, the projection objective in the embodiment will be introduced.

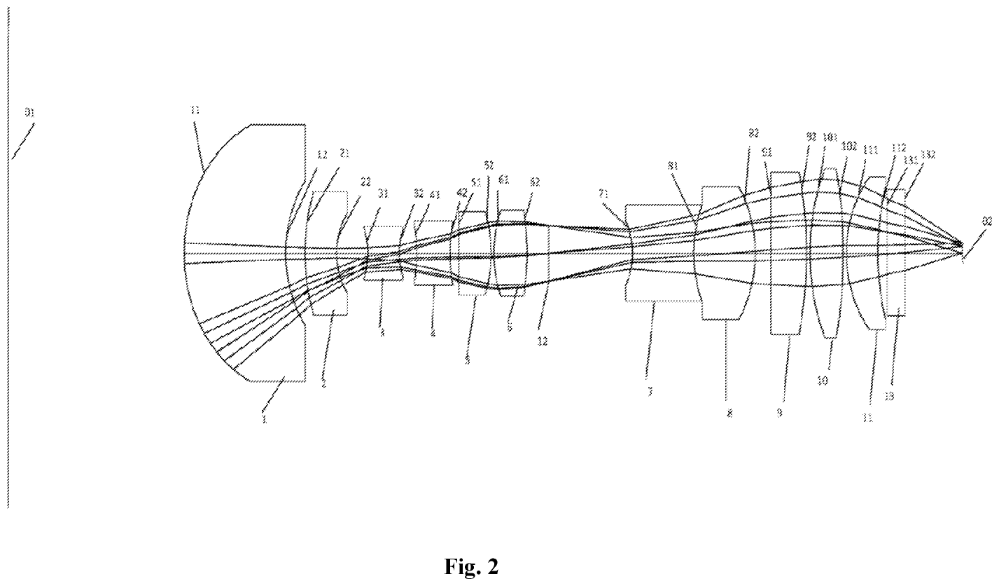

FIG. 2 is a schematic structure of the projection objective provided according to an embodiment. The projection objective includes a first lens group and a second lens group which are sequentially provided on a common optical axis from an object side to an image side. The first lens group includes six lenses, i.e. a first lens 1 to a sixth lens 6, which are sequentially provided from the object side to the image side and have positive, negative, negative, negative, positive, and positive focal lengths in sequence. The first lens 1 has an object side surface 111 being a convex surface and an image side surface 112 being a concave surface. The second lens group includes five lenses, i.e. a seventh lens 7 to an eleventh lens 11, which are sequentially provided from the object side to the image side and have negative, positive, positive, positive, and positive focal lengths in sequence. The seventh lens 7 is a biconcave lens, and an eighth lens 8 is a biconvex lens, the seventh lens 7 and the eighth lens 8 forming a bi-cemented lens having a convex surface facing the image side. The eleventh lens 11 has an object side surface 111 being a convex surface and an image side surface 112 being a concave surface. In this projection objective, by setting focal lengths of respective lenses, a focal power of a system can be reasonably dispersed, thereby reducing an image difference generated by respective lenses and forming a clear image of the arc-shaped image surface.

The expression of “from an object side to an image side” used herein refers to a direction from an object surface 01 to an image surface 02 in FIG. 2. An object side surface being a convex surface refers to that the object side surface faces the object surface 01 of the projection objective and forms a raised shape. The object side surface being a concave surface refers to that the object side surface faces the object surface 01 and forms a depressed shape. An image side surface being a convex surface refers to that the image side surface faces the image surface 02 of the projection objective and forms a raised shape. The image side surface being a concave surface refers to that the image side surface faces the image surface 02 and forms a depressed shape.

In the embodiment, the first lens group has a focal length of F1, and the second lens group has a focal length of F2, F1 and F2 satisfying a relational expression: 1.5<F1/F2<2.0. In some embodiments, F1 and F2 satisfying a relational expression: 1.75<F1/F2<1.89, so as to disperse a focal power of the system and reduce an image difference generated by respective lenses.

In actual application, the first lens 1 is a meniscus-shaped lens having a convex surface facing the object surface 01, and may converge light to a lens. The first lens has a curvature radius of R1 at the object side surface 111 and a curvature radius of R2 at the image side surface 112, R1 and R2 satisfying a relational expression: 1.4>R1/R2>1. When the curvature radiuses are in this ratio range, the first lens 1 can effectively converge light in a desired field to the lens.

In the embodiment, a second lens 2 with a negative focal length has an object side surface 21 being a convex surface and an image side surface 22 being a concave surface. A third lens 3 and a fourth lens 4, each with a negative focal length, are both biconcave lenses. The third lens 3 has an object side surface 31 and an image side surface 32 both being concave surfaces, and the fourth lens 4 has an object side surface 41 and an image side surface 42 both being concave surfaces. A fifth lens 5 with a positive focal length has an object side surface 51 being a flat surface and an image side surface 52 being a convex surface. The sixth lens 6 is a biconvex lens, and has an object side surface 61 and an image side surface 62 both being convex surfaces.

In an alternative embodiment, the second lens 2, the third lens 3, and the fourth lens 4 have equivalent focal lengths of F3, and the fifth lens and the sixth lens have equivalent focal lengths of F4, F3 and F4 satisfying a relational expression: 4<|F4/F3|<10.

Further, in actual application, a design structure and even the number of lenses of the three lenses, i.e., the second lens 2 to the fourth lens 4, may be adjusted based on F3, and/or a design structure and even the number of lenses of the two lenses, i.e., the fifth lens 5 and the sixth lens 6, may be adjusted based on F4, as long as these two groups of lenses have equivalent distances which satisfy the above ratio relation of F3 and F4 and can act on the light correspondingly as required. The disclosure does not make any specific limitation to these.

In some embodiments, a stop 12 may be disposed on a common optical axis between the sixth lens 6 and the seventh lens 7 and is configured to reduce stray light and improve the quality of an image. The stop 12 is shown in FIG. 2. A type of the stop 12 is an aperture stop, a field stop, a vignetting stop and the like. If a distance from the image side surface 62 of the sixth lens 6 to the stop 12 on the optical axis is T1 and a distance from the stop 12 to an object side surface 71 of the seventh lens 7 on the optical axis is T2, T1 and T2 satisfy a relational expression: T1<T2, so as to effectively correct an image difference. In some embodiments, T1 and T2 satisfy a relational expression: 1<T2/T1<8, so that a system structure of the projection objective can be more compact.

The seventh lens 7 has the object side surface 71 and an image side surface 72 both being concave surfaces, and the eighth lens 8 has an object side surface 81 and an image side surface 82 both being convex surfaces; and the image side surface 72 of the seventh lens 7 is cemented with the object side surface 81 of the eighth lens 8, so that the seventh lens 7 and the eighth lens 8 form a bi-cemented lens, and the bi-cemented lens has an object (i.e., a screen, a wall and the like) side being a biconcave lens and an image (i.e., a scanning surface) side being a biconvex lens, so as to effectively correct the image difference and reduce optical sensitivity. Besides, a ninth lens 9 has a positive focal length, and has an object side surface 91 which may be a flat surface and an image side surface 92 being a convex surface; a tenth lens 10 is a biconvex lens with a positive focal length, and has an object side surface 101 and an image side surface 102 both being convex surfaces; and further, the eleventh lens 11 with a positive focal length has an object side surface 111 being a convex surface and an image side surface 112 being a concave surface, which may effectively reduce the optical sensitivity.

Since an action of a lens structure on the light has invertibility, an acting effect that the design structure of the projection objective provided in the embodiment on the light from the object surface 01 to the image surface 02 may be understood as follows. The first lens 1 converges the light to the lens, and converged light is further changed to divergent light through the second lens 2, the third lens 3, and the fourth lens 4. The divergent light is converged through the fifth lens 5 and the sixth lens 6 into the stop 12, and then main light in the light emitted from the stop 12 is diverged through the bi-cemented lens towards two sides. Finally, the light is converged through the ninth lens 9, the tenth lens 10, and the eleventh lens 11 to the image surface 02. Accordingly, after the light of the arc-shaped image surface 02 undergoes acting of the projection objective, an arc-shaped image emitted from the optical fiber scanner may be magnified, and a clear image may be formed on a surface (i.e., the object surface 01).

In an alternative embodiment, the projection objective may further include a parallel flat plate 13, which has a common optical axis with the lens groups and is located between the eleventh lens 11 and the image surface 02, as shown in FIG. 2. The parallel flat plate 13 may be formed of a transparent material such as glass and plastics, and may be configured to protect the lenses in the projection objective, for example, to avoid scratching of the eleventh lens 11 during adjustment of the optical fiber.

In the embodiment, refractive indexes of respective lens in the projection objective satisfy following relational expressions:

1.7<N1<1.9,

1.8<N2<2.0,

1.85<N3<2.0,

1.46<N4<1.65,

1.8<N5<2.0,

1.46<N6<1.65,

1.85<N7<2.0,

1.46<N8<1.65,

1.46<N9<1.65,

1.46<N10<1.65,

1.65<N11<1.85, and

1.46<NX<1.65,
where N1 is a refractive index of the first lens 1, N2 being a refractive index of the second lens 2, N3 being a refractive index of the third lens 3, N4 being a refractive index of the fourth lens 4, N5 being a refractive index of the fifth lens 5, N6 being a refractive index of the sixth lens 6, N7 being a refractive index of the seventh lens 7, N8 being a refractive index of the eighth lens 8, N9 being a refractive index of a ninth lens 9, N10 being a refractive index of a tenth lens 10, N11 being a refractive index of the eleventh lens 11, NX being a refractive index of the parallel flat plate 13.

In the projection objective provided in the embodiment, the lenses may be formed of glass, plastics or other materials. In some embodiments, if the lenses are formed of glass, a degree of freedom for configuring a refraction power may be increased. Herein, an introduction is made mainly by taking the lenses in the projection objective being formed of glass as an example, and different lenses in the projection objective may be formed of glass having different refractive indexes or chromatic dispersion parameters.

In some embodiments, the second lens 2 and the fifth lens 5 may be formed of the same material, for example, a glass material with a higher refractive index (for example, a refractive index higher than 1.65) and a lower chromatic dispersion coefficient (for example, a chromatic dispersion coefficient less than 30). Meanwhile, the third lens 3 and the seventh lens 7 may also be formed of the same material, for example, a glass material with a high refractive index and a low chromatic dispersion coefficient. Further, the fourth lens 4, the sixth lens 6, the eighth lens 8, the ninth lens 9, and the tenth lens 10 may also be formed of the same material, for example, a glass material with a low refractive index and a high chromatic dispersion coefficient (for example, a chromatic dispersion coefficient higher than 60). Besides, each of respective lenses has a spherical-shape surface, which is beneficial for optical cold processing.

As an embodiment of the disclosure, the projection objective has an overall equivalent focal length of 2 mm, and when the projection objective is used to form an image of a light emission surface which is a cylinder surface (a curvature radius corresponding to a scanning trajectory in a fast axis direction is 2 mm), preferred parameters of curvature radiuses, thickness parameters, and distances of respective lenses are as shown in Table 1.

TABLE 1

| | | | Curvature | Curvature | Thickness/ | Thickness/ |
|---|---|---|---|---|---|---|
| Optical | | | radius | radius | distance | distance |
| surface | Lens | Type | number | (mm) | number | (mm) |
| Object | | Standard | | Infinity | | Infinity |
| surface | | surface | | | | |
| 11 | First | Standard | R1 | 6.528 | L1 | 5.801 |
| | lens | surface | | | | |
| 12 | | Standard | R2 | 5.600 | L2 | 1.100 |
| | | surface | | | | |
| 21 | Second | Standard | R3 | 8.490 | L3 | 1.807 |
| | lens | surface | | | | |
| 22 | | Standard | R4 | 3.100 | L4 | 1.782 |
| | | surface | | | | |
| 31 | Third | Standard | R5 | −3.223 | L5 | 1.800 |
| | lens | surface | | | | |
| 32 | | Standard | R6 | 3.223 | L6 | 1.000 |
| | | surface | | | | |
| 41 | Fourth | Standard | R7 | −5.470 | L7 | 1.869 |
| | lens | surface | | | | |
| 42 | | Standard | R8 | 5.470 | L8 | 0.535 |
| | | surface | | | | |
| 51 | Fifth | Standard | R9 | Infinity | L9 | 1.808 |
| | lens | surface | | | | |
| 52 | | Standard | R10 | −5.680 | L10 | 0.158 |
| | | surface | | | | |
| 61 | Sixth | Standard | R11 | 5.150 | L11 | 1.903 |
| | lens | surface | | | | |
| 62 | | Standard | R12 | −9.610 | L12 | 1.239 |
| | | surface | | | | |
| Stop | | | | Infinity | L13 | 4.775 |
| 71 | Seventh | Standard | R13 | −3.054 | L14 | 3.500 |
| | lens | surface | | | | |
| 81 | Eighth | Standard | R14 | 5.540 | L15 | 3.500 |
| | lens | surface | | | | |
| 82 | | Standard | R15 | −5.540 | L16 | 0.890 |
| | | surface | | | | |
| 91 | Ninth | Standard | R16 | Infinity | L17 | 2.043 |
| | lens | surface | | | | |
| 92 | | Standard | R17 | −16.550 | L18 | 0.196 |
| | | surface | | | | |
| 101 | Tenth | Standard | R18 | 9.400 | L19 | 1.915 |
| | lens | surface | | | | |
| 102 | | Standard | R19 | −18.961 | L20 | 0.174 |
| | | surface | | | | |
| 111 | Eleventh | Standard | R20 | 5.432 | L21 | 1.801 |
| | lens | surface | | | | |
| 112 | | Standard | R21 | 11.200 | L22 | 0.600 |
| | | surface | | | | |
| 131 | Parallel | Standard | R22 | Infinity | L23 | 1.000 |
| | flat plate | surface | | | | |
| 132 | | Standard | R23 | Infinity | L24 | 3.198 |
| | | surface | | | | |
| Image | | Cylinder | | 2 | | |
| surface | | surface | | | | |

As shown in Table 1, curvature radius numbers of the object side surface 111 and the image side surface 112 of the first lens 1 are respectively R1 and R2; curvature radius numbers of the object side surface 21 and the image side surface 22 of the second lens 2 are respectively R3 and R4; curvature radius numbers of the object side surface 31 and the image side surface 32 of the third lens 3 are respectively R5 and R6; curvature radius numbers of the object side surface 41 and the image side surface 42 of the fourth lens 4 are respectively R7 and R8; curvature radius numbers of the object side surface 51 and the image side surface 52 of the fifth lens 5 are respectively R9 and R10; curvature radius numbers of the object side surface 61 and the image side surface 62 of the sixth lens 6 are respectively R11 and R12; a curvature radius number of the object side surface 71 of the seventh lens is R13; curvature radius numbers of the object side surface 81 and the image side surface 82 of the eighth lens 8, which is cemented to the seventh lens 7, are respectively R14 and R15; curvature radius numbers of the object side surface 91 and the image side surface 92 of the ninth lens 9 are respectively R16 and R17; curvature radius numbers of the object side surface 101 and the image side surface 102 of the tenth lens 10 are respectively R18 and R19; curvature radius numbers of the object side surface 111 and the image side surface 112 of the eleventh lens 11 are respectively R20 and R21; and curvature radius numbers of an object side surface 131 and an image side surface 132 of the parallel flat plate 13 are respectively R22 and R23.

In Table 1, a center distance between the object side surface 111 of the first lens 1 and the image surface 02 (i.e., a total optical length) being 44.39 mm is taken as an example. Respective lens in the projection objective are all formed of a glass material. An optical surface with a curvature radius of “infinity” in a lens refers to a flat surface. A distance parameter corresponding to the object surface 01 refers to a projection distance of a projection lens, and the projection distance may be set according to actual circumstances. L1 is a thickness of the first lens 1, and L2 is a distance from the image side surface 112 of the first lens 1 to the object side surface 21 of the second lens 2 on the optical axis; L3 is a thickness of the second lens 2, and L4 is a distance from the image side surface 22 of the second lens 2 to the object side surface 31 of the third lens 3 on the optical axis; L5 is a thickness of the third lens 3, and L6 is a distance from the image side surface 32 of the third lens 3 to the object side surface 41 of the fourth lens 4 on the optical axis; L7 is a thickness of the fourth lens 4, and L8 is a distance from the image side surface 42 of the fourth lens 4 to the object side surface 51 of the fifth lens 5 on the optical axis; L9 is a thickness of the fifth lens 5, and L10 is a distance from the image side surface 52 of the fifth lens 5 to the object side surface 61 of the sixth lens 6 on the optical axis; L11 is a thickness of the sixth lens 6, and L12 is a distance from the image side surface 62 of the sixth lens 6 to the stop 12 on the optical axis; L13 is a thickness of the stop 12; L14 is a thickness of the seventh lens 7; L15 is a thickness of the eighth lens 8, and L16 is a distance from the image side surface 82 of the eighth lens 8 to the object side surface 91 of the ninth lens 9 on the optical axis; L17 is a thickness of the ninth lens 9, and L18 is a distance from the image side surface 92 of the ninth lens 9 to the object side surface 101 of the tenth lens 10 on the optical axis; L19 is a thickness of the tenth lens 10, and L20 is a distance from the image side surface 102 of the tenth lens 10 to the object side surface 111 of the eleventh lens 11 on the optical axis; L21 is a thickness of the eleventh lens 11, and L22 is a distance from the image side surface 112 of the eleventh lens 11 to the object side surface 131 of the parallel flat plate 13 on the optical axis; and L23 is a thickness of the parallel flat plate 13, and L24 is a distance from the image side surface 132 of the parallel flat plate 13 to the image surface 02 on the optical axis.

A rear working distance of the above projection objective (i.e., a center distance between the image side surface 132 of the parallel flat plate 13 and the image surface 02) is 3.198 mm. A ratio (D/F′) of a relative aperture size, i.e., an effective entrance pupil focal distance (D), to an overall equivalent focal length (F′) may be improved to 0.5, which can effectively improve the light use efficiency.

Further, as an embodiment of the disclosure, respective lens of the projection objective is all formed of a glass material, and an overall focal length of the projection objective is 2 mm. Preferred parameters of refractive indexes and chromatic dispersion coefficients of respective lens are as shown in Table 2.

TABLE 2

| | | | Chromatic |
|---|---|---|---|
| | | Refractive | dispersion |
| | Material | index of a | coefficient |
| Lens | of a lens | lens | of a lens |
| First lens | Glass | 1.8 | 39.6 |
| Second lens | Glass | 1.91 | 35.3 |
| Third lens | Glass | 1.95 | 17.9 |
| Fourth lens | Glass | 1.55 | 63.4 |
| Fifth lens | Glass | 1.91 | 35.3 |
| Sixth lens | Glass | 1.55 | 63.4 |
| Seventh lens | Glass | 1.95 | 17.9 |
| Eighth lens | Glass | 1.55 | 63.4 |
| Ninth lens | Glass | 1.55 | 63.4 |
| Tenth lens | Glass | 1.55 | 63.4 |
| Eleventh lens | Glass | 1.7 | 30.1 |
| Parallel | Glass | 1.55 | 30.1 |
| flat plate | | | |

In Table 2, the second lens 2 and the fifth lens 5 are formed of the same glass material with a higher refractive index and lower chromatic dispersion; the third lens 3 and the seventh lens 7 are formed of the same glass material with a high refractive index and low chromatic dispersion; and the fourth lens 4, the sixth lens 6, the eighth lens 8, the ninth lens 9, and the tenth lens 10 are formed of glass with a low refractive index and a high chromatic dispersion coefficient.

In an actual scanning and projection system, when the above projection objective is applied to an optical fiber scanning and projection system, if an arc-shaped scanning surface (i.e., the image surface 02 of the projection objective) formed by optical fiber scanning in an optical fiber scanner has a curvature radius of Rₖ corresponding to a scanning trajectory in a fast axis direction, Rₖ∈[2.0 mm, 2.3 mm], and a curvature radius of Rₘ corresponding to a scanning trajectory in a slow axis direction, Rₘ∈[2.3 mm, +∞), the above projection objective with an equivalent focal length of 2 mm may be used to form an image of an arc-shaped pattern (a scanning surface) emitted from the optical fiber scanner.

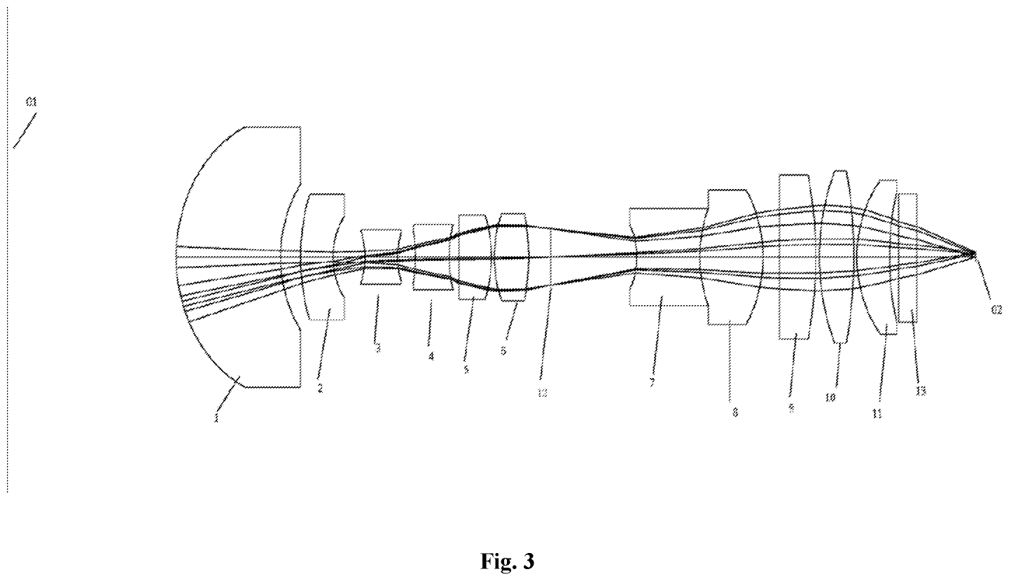

For an imaging process, by the above projection lens, of light emitted from an optical fiber light emission end when scanning is performed in the fast axis direction, reference can be made to FIG. 2. An imaging process of the image surface 02, by the above projection lens, of light emitted from the optical fiber light emission end when scanning is performed in the slow axis direction can be seen FIG. 3. In FIG. 3, a scanning trajectory in the slow axis direction being a straight line (i.e., a curvature radius corresponding to the scanning trajectory being “+∞”) is taken as an example.

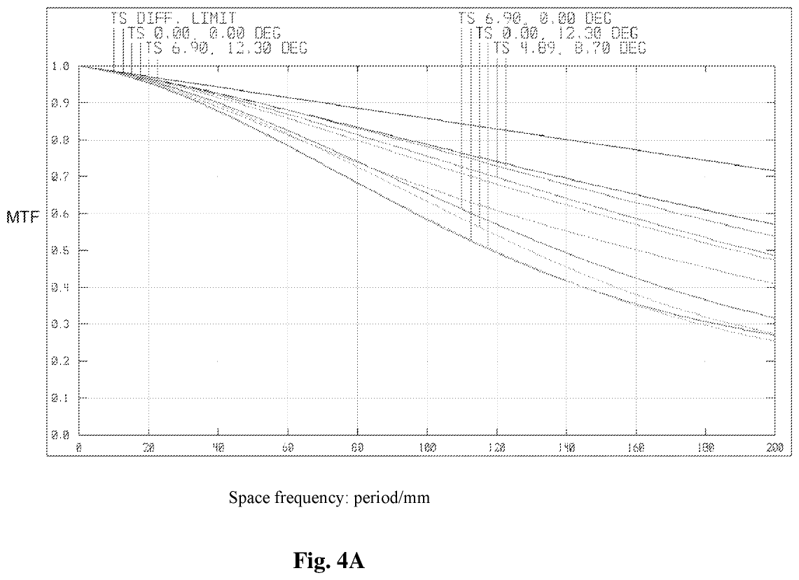

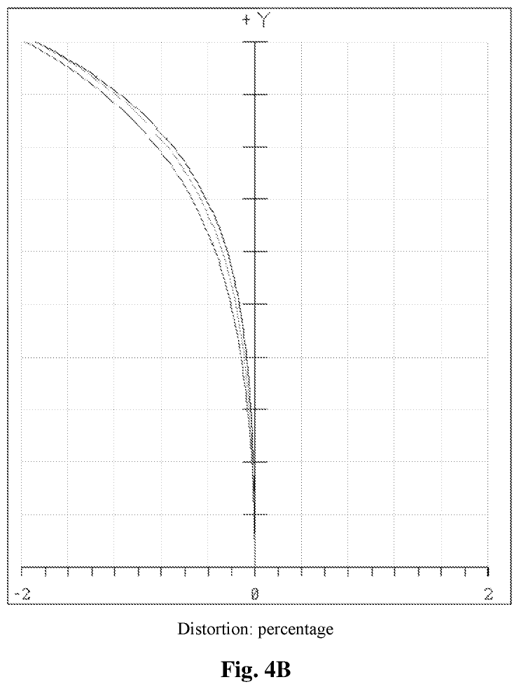

After testing, when Rₖ=2 mm and Rₘ=+∞, a modulation transfer function curve graph and a distortion curve graph of the above projection objective are respectively as shown in FIG. 4A and FIG. 4B. The modulation transfer function (MTF) curve graph represents a comprehensive resolution level of an optical system, and the distortion curve graph indicates an F-Tan (theta) distortion value under different fields.

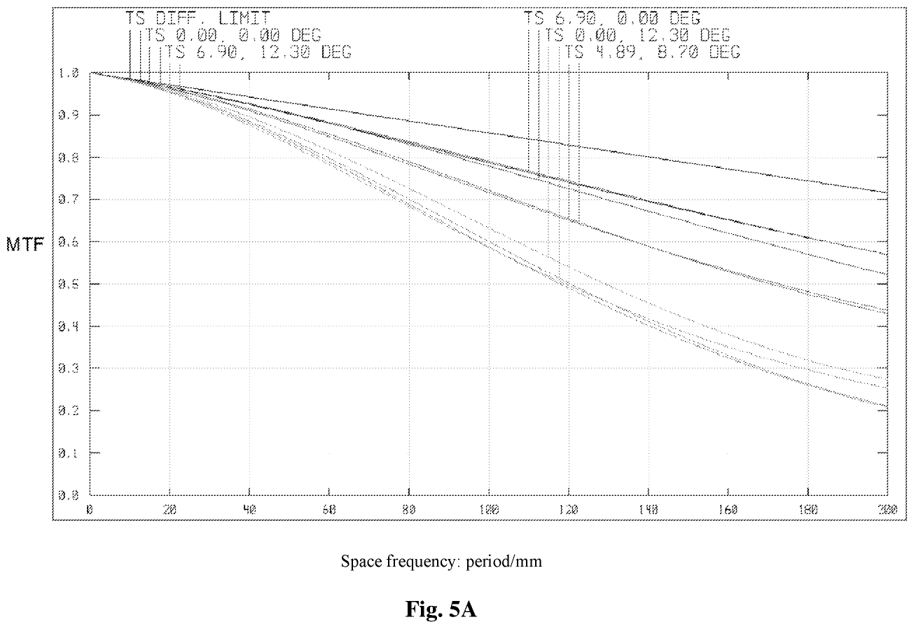

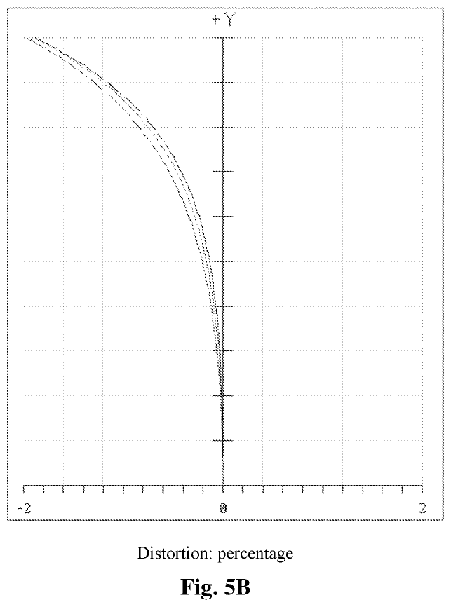

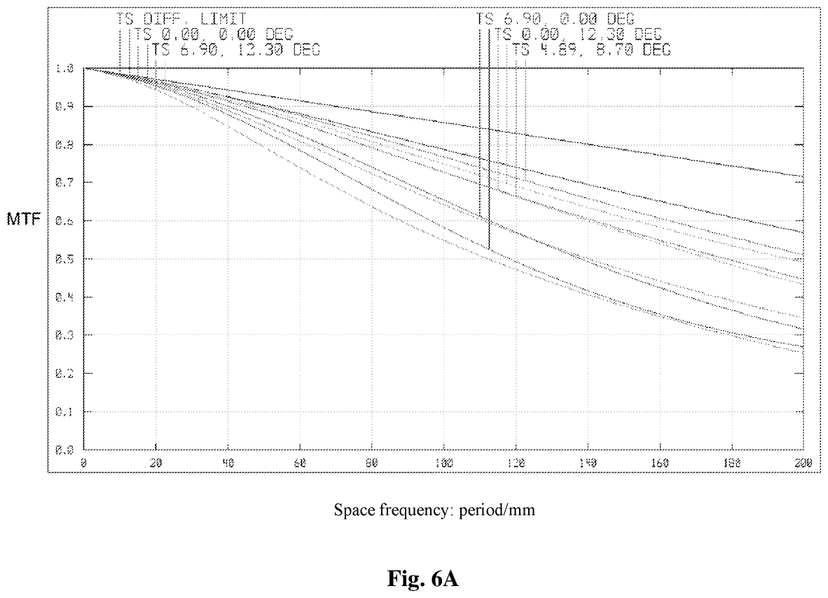

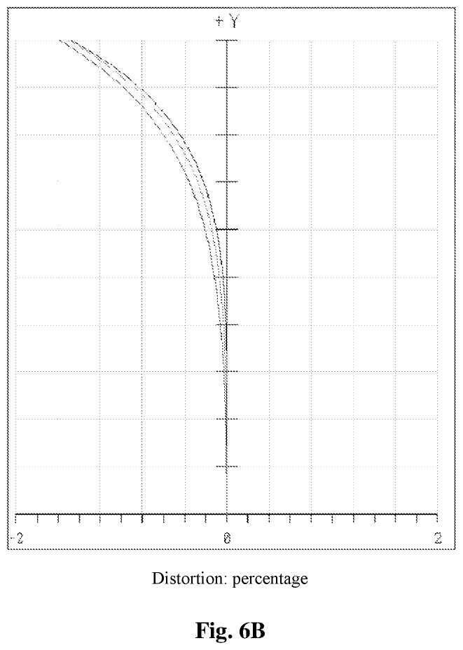

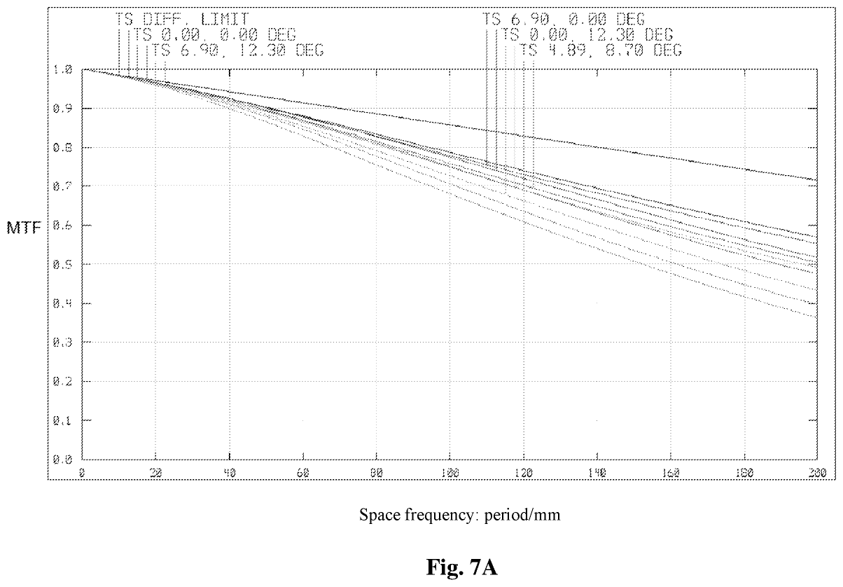

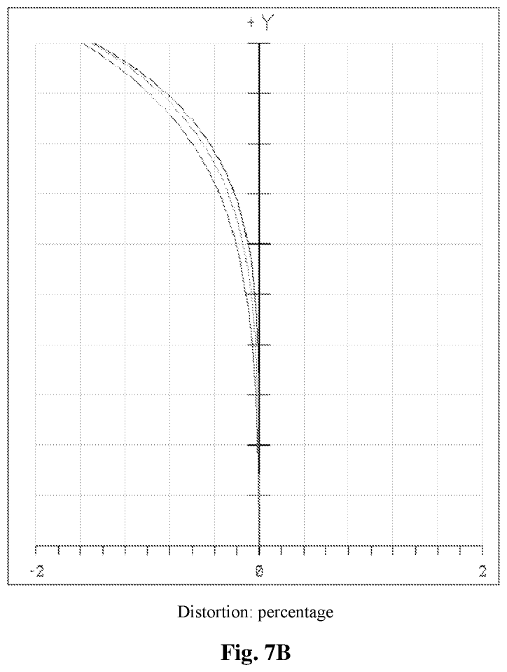

Further, when Rₖ=2 mm and Rₘ=2.5 mm, for an imaging process, by the above projection lens, of the image surface 02, reference can still be made to FIG. 2. An MTF curve graph and a distortion curve graph of the projection objective are respectively as shown in FIG. 5A and FIG. 5B. When Rₖ=2.3 mm and Rₘ=+∞, an MTF curve graph and a distortion curve graph of the projection objective are respectively as shown in FIG. 6A and FIG. 6B. When Rₖ=2.3 mm and Rₘ=2.3 mm, an MTF curve graph and a distortion curve graph of the projection objective are respectively as shown in FIG. 7A and FIG. 7B.

It can be seen, from the MTF curve graphs of the projection objective in FIG. 4A, FIG. 5A, and FIG. 6A, that: MTFs at the center 1601 p/mm are all greater than 0.3, and MTFs at the edge 2001 p/mm are all greater than 0.2. An MTF at the center and an MTF at the edge in FIG. 7A are both greater than 0.3. An imaging resolution is good. It can be seen, from the distortion curve graphs in FIG. 4B, FIG. 5B, FIG. 6B, and FIG. 7B that: an absolute value of distortion of the optical system of the projection objective is less than 2%, and the distortion is good in an overall field. Therefore, this projection objective can form a clear image for optical fiber scanners with the above several scanning radiuses, and can achieve better imaging effects.

The above description involves only preferred specific embodiments of the disclosure, and respective embodiments are only used to illustrate solutions of the disclosure rather than limit the disclosure. Solutions that can be obtained by those skilled in the art through logical analysis, inference, or effective experiments according to the idea of the disclosure shall all fall into the scope of the disclosure.

In the disclosure, by setting respective focal lengths of eleven lenses in two lens groups of the projection objective, a focal power of a system can be effectively dispersed, thereby reducing an image difference generated by respective lenses and forming a clear image of an arc-shaped image surface.

All features or steps in a method or process disclosed in the description, except those features and/or steps exclusive to each other, may be combined in any manner.

Unless otherwise stated, any feature disclosed in the description (including any additional claims, the abstract, and the drawings) may be replaced by an equivalent feature or an alternative feature with the similar purpose. That is, unless otherwise stated, each feature is only one example of a series equivalent or similar features.

The disclosure is not limited to the above specific embodiments. The disclosure may expand to any new feature or any new combination and any step of a new method or process or any new combination disclosed in the description.

1. A projection objective, wherein the projection objective comprises a first lens group and a second lens group which are sequentially provided on a common optical axis from an object side to an image side;
wherein the first lens group comprises six lenses, i.e. a first lens to a sixth lens, which are sequentially provided from the object side to the image side and have positive, negative, negative, negative, positive, and positive focal lengths in sequence, wherein the first lens has an object side surface being a convex surface and an image side surface being a concave surface; and
wherein the second lens group comprises five lenses, i.e. a seventh lens to an eleventh lens, which are sequentially provided from the object side to the image side and have negative, positive, positive, positive, and positive focal lengths in sequence, wherein the seventh lens is a biconcave lens, and an eighth lens is a biconvex lens, the seventh lens and the eighth lens forming a bi-cemented lens having a convex surface facing the image side; and the eleventh lens has an object side surface being a convex surface and an image side surface being a concave surface.

2. The projection objective according to claim 1, wherein a second lens has an object side surface being a convex surface and an image side surface being a concave surface; and wherein a third lens and a fourth lens are both biconcave lenses, a fifth lens has an image side surface being a convex surface, and the sixth lens is a biconvex lens.

3. The projection objective according to claim 1, wherein the first lens group has a focal length of F1, and the second lens group has a focal length of F2, F1 and F2 satisfying a following relational expression:
1.5<F1/F2<2.0.

4. The projection objective according to claim 1, wherein the first lens has a curvature radius of R1 at the object side surface and a curvature radius of R2 at the image side surface, R1 and R2 satisfying a following relational expression:
1<R1/R2<1.4.

5. The projection objective according to claim 4, wherein the second lens, the third lens, and the fourth lens have equivalent focal lengths of F3, and the fifth lens and the sixth lens have equivalent focal lengths of F4, F3 and F4 satisfying a following relational expression:
4<|F4/F3|<10.

6. The projection objective according to claim 4, wherein a distance between the object side surface of the first lens and an image surface of the projection objective is less than 4.5 cm.

7. The projection objective according to claim 1, wherein following relational expressions are further satisfied:
1.7<N1<1.9,
1.8<N2<2.0,
1.85<N3<2.0,
1.46<N4<1.65,
1.8<N5<2.0,
1.46<N6<1.65,
1.85<N7<2.0,
1.46<N8<1.65,
1.46<N9<1.65,
1.46<N10<1.65, and
1.65<N11<1.85,
where N1 is a refractive index of the first lens, N2 being a refractive index of the second lens, N3 being a refractive index of the third lens, N4 being a refractive index of the fourth lens, N5 being a refractive index of the fifth lens, N6 being a refractive index of the sixth lens, N7 being a refractive index of the seventh lens, N8 being a refractive index of the eighth lens, N9 being a refractive index of a ninth lens, N10 being a refractive index of a tenth lens, N11 being a refractive index of the eleventh lens.

8. The projection objective according to claim 7, wherein the second lens and the fifth lens are formed of the same material.

9. The projection objective according to claim 7, wherein the third lens and the seventh lens are formed of the same material.

10. The projection objective according to claim 7, wherein the fourth lens, the sixth lens, the eighth lens, the ninth lens, and the tenth lens are formed of the same material.

11. The projection objective according to claim 1, wherein the projection objective further comprises a stop, which is disposed on a common optical axis between the sixth lens and the seventh lens.

12. The projection objective according to claim 11, wherein a distance from an image side surface of the sixth lens to the stop is T1, and a distance from the stop to an object side surface of the seventh lens is T2, T1 and T2 satisfying a relational expression:
T1<T2.

13. The projection objective according to claim 1, wherein the projection objective further comprises:
a parallel flat plate, which is located between the eleventh lens and the image surface of the projection objective on a common optical axis with the eleventh lens for protecting the projection objective.

14. A scanning display device, wherein the scanning display device comprises an optical fiber scanner and the projection objective according to claim 1 corresponding to the optical fiber scanner; wherein the optical fiber scanner comprises an actuator and an optical fiber fixed on the actuator, and a portion of the optical fiber that goes beyond the actuator forms an optical fiber cantilever; wherein the actuator comprises a first actuating portion and a second actuation portion connected to the first actuating portion; and wherein under action of a driving signal, the first actuating portion moves in a first direction, the second actuating portion driving the first actuating portion to move in a second direction, the optical fiber cantilever moving in a combined direction of the first direction and the second direction, wherein the first actuating portion has a movement frequency which is greater than or equal to a movement frequency of the second actuator.

15. The scanning display device according to claim 14, wherein a curvature radius corresponding to a scanning trajectory of the optical fiber in the first direction driven by the actuator is [2.0 mm, 2.3 mm], and a curvature radius corresponding to a scanning trajectory in the second direction is [2.3 mm, +∞], an equivalent focal length of the projection objective being 2 mm.
